(19) United States
(12) Patent Application Publication
(10) Pub. No.: US 2026/0348235 A1
(43) Pub. Date: Nov. 5, 2026

(54) INTEGRATED LADDER ATTACHMENT

(71) Applicant: YSC, Inc., Harvard, MA (US)

(72) Inventor: Thomas Evarts, Harvard, MA (US)

(21) Appl. No.: 19/194,608

(22) Filed: Apr. 30, 2025

(51) Int. Cl. E06C 7/16

(52) U.S. Cl. CPC E06C 7/16

(57) ABSTRACT

An integrated ladder attachment includes a first hollow crossbar, the first crossbar disposed between a first pair of rungs on a ladder and a second hollow crossbar, the second crossbar disposed between a second pair of rungs on a ladder. A first beam is attached to the first crossbar and proceeds substantially perpendicular therefrom away from the ladder. A support beam is attached to the first beam and proceeds angularly toward the ladder. A second beam is attached to the first beam and proceeds substantially perpendicularly therefrom and substantially parallel to the axis of the ladder. The second beam is also attached the support beam. A first pin is disposed within the first hollow crossbar, and a second pin is disposed within the second hollow crossbar.

### FIELD

Illustrative embodiments of the invention generally relate to ladders and, more particularly, various embodiments of the invention relate to an integrated ladder attachment.

### BACKGROUND

Conventional ladder attachments have two portions that fit over the rungs of a ladder (to secure to the ladder), and an elongated portion extending from the ladder to receive a board. However, the use of conventional ladder attachments may not provide a secure mount to a ladder.

### SUMMARY OF VARIOUS EMBODIMENTS

In accordance with one embodiment of the invention, an integrated ladder attachment includes a first hollow crossbar having a first end and a second end, the first crossbar disposed between a first pair of rungs on a ladder and between a first and a second siderail of the ladder; a second hollow crossbar having a first end and a second end, the second crossbar disposed between a second pair of rungs on a ladder and between the first and the second siderail of the ladder; a first beam having a first end and a second end, the first end of the first beam attached to the first crossbar and proceeding substantially perpendicular therefrom away from the ladder; a support beam having a first end and a second end, the first end of the support beam attached to the first beam and proceeding angularly toward the ladder; a second beam having a first end and a second end, the first end of the second beam attached proximate the first end of the first beam and proceeding substantially perpendicularly therefrom and substantially parallel to the axis of the ladder, and wherein the second end of the second beam is attached proximate to the second end of the support beam; a first pin, disposed within the first hollow crossbar, the first pin proceeding through the first siderail of the ladder and through the second siderail of the ladder; and a second pin, disposed within the second hollow crossbar, the second pin proceeding through the first siderail of the ladder and through the second siderail of the ladder.

In some embodiments, the integrated ladder attachment further includes a first inner reinforcement plate attached to an inner side of the first siderail; a second inner reinforcement plate attached to an inner side of the second siderail; a first outer reinforcement plate attached to an outer side of the first siderail; and a second outer reinforcement plate attached to an outer side of the second siderail, wherein the first pin is inserted through the first outer reinforcement plate, the first inner reinforcement plate, the second inner reinforcement plate and the second outer reinforcement plate.

In some embodiments, the first inner reinforcement plate, the second inner reinforcement plate, the first outer reinforcement plate and the second outer reinforcement plate each include one or more openings.

In some embodiments, the integrated ladder attachment further includes one or more fasteners through each of the one or more openings.

In some embodiments, the first inner reinforcement plate, the second inner reinforcement plate, the first outer reinforcement plate and the second outer reinforcement plate each include a flange.

In some embodiments, each flange is circular and wherein the first pin is inserted through each flange.

In some embodiments, the first pin includes an opening proximate to the first end of the first pin, and the first outer reinforcement plate flange includes one or more openings.

In some embodiments, the integrated ladder attachment further includes a bail pin inserted into the opening at the first end of the first pin and the one or more openings of the flange of the first outer reinforcement plate.

In some embodiments, the first pin comprises an opening proximate to the second end of the first pin, and the second outer reinforcement plate flange includes one or more openings.

In some embodiments, the integrated ladder attachment further includes a bail pin inserted into the opening at the second end of the first pin and the one or more openings of the flange of the second outer reinforcement plate.

In some embodiments, the first end of the first beam is attached generally centrally to the first crossbar.

In some embodiments, the support beam is attached generally centrally to the second crossbar.

In some embodiments, the integrated ladder attachment further includes one or more knife plates attached at the first end of the first beam.

In some embodiments, a first knife plate of the one or more knife plates is disposed on an opposite side of the first beam from a second knife plate of the one or more knife plates.

In some embodiments, the integrated ladder attachment further includes a guard rail post receiver disposed at the second end of the first beam.

In accordance with one embodiment of the invention, a ladder includes a first siderail having an outer side and an inner side; a second siderail having an outer side and an inner side; one or more spaced rungs proceeding between the inner side of the first siderail and the inner side of the second siderail; and a first ladder attachment. The first ladder attachment includes a first hollow crossbar having a first end and a second end, the first crossbar disposed between a first pair of rungs on the ladder and between the inner sides of the first and a second siderail of the ladder; a second hollow crossbar having a first end and a second end, the second crossbar disposed between a second pair of rungs on a ladder and between the inner sides of the first and the second siderail of the ladder; a first beam having a first end and a second end, the first end of the first beam attached to the first crossbar and proceeding substantially perpendicular therefrom away from the ladder; a support beam having a first end and a second end, the first end of the support beam attached to the first beam and proceeding angularly toward the ladder; a second beam having a first end and a second end, the first end of the second beam attached proximate the first end of the first beam and proceeding substantially perpendicularly therefrom and substantially parallel to the axis of the ladder, and wherein the second end of the second beam is attached proximate to the second end of the support beam; a first pin, disposed within the first hollow crossbar, the first pin proceeding through the first siderail of the ladder and through the second siderail of the ladder; and a second pin, disposed within the second hollow crossbar, the second pin proceeding through the first siderail of the ladder and through the second siderail of the ladder.

In some embodiments, the ladder further includes a first inner reinforcement plate attached to an inner side of the first siderail; a second inner reinforcement plate attached to an inner side of the second siderail; a first outer reinforcement plate attached to an outer side of the first siderail; and a second outer reinforcement plate attached to an outer side of the second siderail, wherein the first pin is inserted through the first outer reinforcement plate, the first inner reinforcement plate, the second inner reinforcement plate and the second outer reinforcement plate.

In some embodiments, the first inner reinforcement plate, the second inner reinforcement plate, the first outer reinforcement plate and the second outer reinforcement plate each include one or more openings, wherein one or more fasteners is disposed through each of the one or more openings.

In some embodiments, the first inner reinforcement plate, the second inner reinforcement plate, the first outer reinforcement plate and the second outer reinforcement plate each include a flange.

In some embodiments, each flange is circular and wherein the first pin is inserted through each flange.

### BRIEF DESCRIPTION OF THE DRAWINGS

Those skilled in the art should more fully appreciate advantages of various embodiments of the invention from the following “Description of Illustrative Embodiments,” discussed with reference to the drawings summarized immediately below.

FIG. 1 is a perspective view of an example ladder with integrated ladder attachment in accordance with various embodiments.

FIG. 2A is a perspective view of a section of the example ladder with integrated ladder attachment of FIG. 1 in accordance with various embodiments.

FIG. 2B is a right elevation view of the section of the example ladder with integrated ladder attachment of FIG. 2A in accordance with various embodiments.

FIG. 3 is a sectional view of a portion of the integrated ladder attachment of FIGS. 2A and 2B in accordance with various embodiments.

FIG. 4A is a side elevation of an inner reinforcement plate of the integrated ladder attachment in accordance with various embodiments.

FIG. 4B is a front elevation of the inner reinforcement plate of the integrated ladder attachment in accordance with various embodiments.

FIG. 5A is a side elevation of an outer reinforcement plate of the integrated ladder attachment in accordance with various embodiments.

FIG. 5B is a front elevation of the outer reinforcement plate of the integrated ladder attachment in accordance with various embodiments.

### DESCRIPTION OF ILLUSTRATIVE EMBODIMENTS

In illustrative embodiments, an integrated ladder attachment is described herein. In various embodiments, the integrated ladder attachment has two horizontal posts secured to the side rails of the ladder. One of the posts is secured higher up on the ladder while the other is lower down. Unlike conventional ladder attachments, the ladder attachment described herein does not take up a rung of the ladder.

To ensure security, in various embodiments, the ladder may be reinforced at the points where the horizonal posts meet the ladder. In various embodiments, the ladder attachment may be fixed and not movable. In various embodiments, the ladder attachment may be removable from the ladder.

In various embodiments, the ladder attachment is fit at the end of a horizontal elongated portion. Accordingly, while the ladder attachment serves as a stop for the board laid on the ladder attachment, it also forms a fitting to receive a pole or other component. This pole can form a portion of a scaffolding-type structure that can receive netting to catch debris falling from above. Details of illustrative embodiments are discussed below with reference to the drawings.

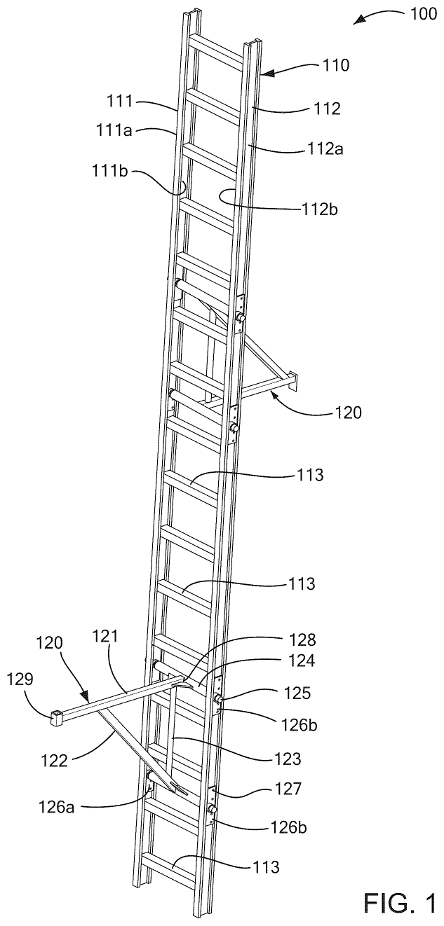

Referring now to the drawings, wherein like reference numerals represent like features across the several views, FIG. 1 is a perspective view of an example ladder with integrated ladder attachment 100 in accordance with various embodiments.

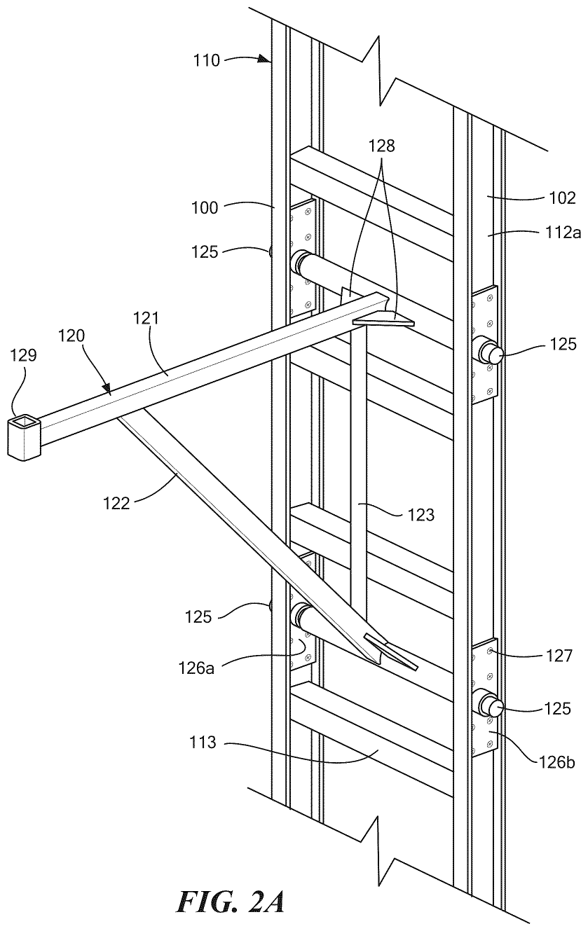

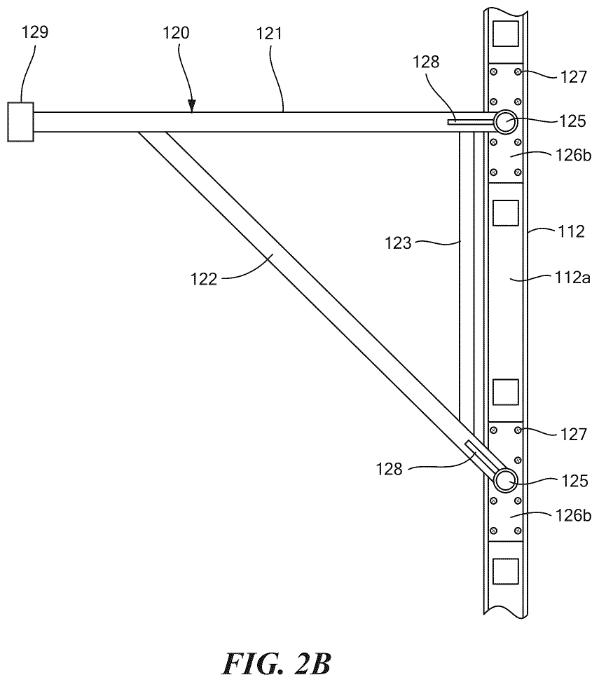

FIG. 2A is a perspective view of a section of the example ladder with integrated ladder 100 attachment of FIG. 1 in accordance with various embodiments.

FIG. 2B is a right elevation view of the section of the example ladder with integrated ladder attachment 100 of FIG. 2A in accordance with various embodiments.

As shown in FIGS. 1, 2A and 2B, the ladder with integrated ladder attachment 100 includes a ladder 110 and a ladder attachment 120. The ladder 110 includes a first siderail 111 and a second siderail 112. In various embodiments, the first siderail may be a left siderail and the second siderail may be a right siderail. In various embodiments, the first siderail 111 and the second siderail 112 provide a holding rail for a person ascending or descending the ladder 110.

The first siderail 111 includes an outer face 111a and an inner face 111b. The second siderail includes an outer face 112a and an inner face 112b. As shown in FIG. 1, the perspective view of the ladder 110 may be viewed wherein the top of the ladder 110 is generally at the top of the view in FIG. 1 and the bottom of the ladder is generally toward the bottom of the view in FIG. 1. Accordingly, as described above, the first siderail 111 may be a siderail for which a user's left hand climbs or descends the ladder 110 while second siderail 112 may be a siderail where the user's right hand climbs or descends the ladder 110.

Attached to the ladder 110 may be one or more integrated ladder attachments 120. In various embodiments, each integrated ladder attachment 120 is integrated into the ladder 110. That is, the ladder attachment 120 does not hang across a rung such as a conventional ladder attachment, but is integral to the structure of the ladder 110.

As shown in FIG. 1, two integrated ladder attachments 120 are attached to the ladder 110. However, persons of skill in the art will appreciate that more or less integrated ladder attachments 120 may be attached to the ladder 110. Further, as shown in FIG. 1, one of the integrated ladder attachments 120 is configured in a first orientation with respect to the ladder 110, while another integrated ladder attachment 120 is configured in a second orientation with respect to the ladder 110. Persons of skill in the art will appreciate that any orientation may be configured for any integrated ladder attachment 120.

Continuing to refer to FIGS. 1, 2A and 2B, the integrated ladder attachment 120 includes a first beam 121, a support beam 122, a second beam 123, and one or more crossbars 124. In various embodiments, the integrated ladder attachment 120 may include two crossbars 124. The crossbars 124 may be hollow and made from a strong material such as aluminum.

In various embodiments, the first beam 121 may be a horizontal beam which is integrated with a first crossbar 124 and proceeding perpendicularly therefrom with respect to the orientation of the ladder 110. The second beam 123 is attached to the first beam 121 at a first end of the first beam 121 proximate to the ladder 110 and, in various embodiments, proceeds perpendicularly from the first end of the first beam 121 generally along a same axis at the ladder 110.

In various embodiments, the first end of the first beam 121 is attached to one of the crossbars 124 generally centrally on the crossbar 124.

A first end of the support beam 122 is attached toward a second end of the first beam 121 (e.g., an end distal to the ladder 110). In various embodiments, the support beam 122 may be attached between halfway and three quarters of the way from the first end of the first beam 121. In various embodiments, the support beam 122 proceeds generally from the point of attachment to the first beam 121 toward the ladder 110, where a second end of the support beam 122 is attached to a second end of the second beam 123.

In various embodiments, the first beam 121, support beam 122 and second beam 123 may form a generally triangular shape. Additionally, the second end of the support beam 122 is attached is attached to another one of the crossbars 124 (e.g., different from the crossbar 124 that the first beam 121 is attached to) generally centrally on the crossbar 124.

The integrated ladder attachment 120 includes a pin 125, inner reinforcement plates 126a and outer reinforcement plates 126b, described in more detail below. In various embodiments, the integrated ladder attachment 120 may include one or more knife plates 128 disposed at the first end of the first beam 121 and the second end of the support beam 122. In various embodiments, the knife plates 128 may be generally triangular in shape and proceed radially from an axis of the first beam 121 and/or support beam 122.

In various embodiments, a guard rail post receiver 129 may be disposed at the second end of the first beam 121 for receiving a post of a guard rail. Also included in the integrated ladder attachment 120 are fasteners 127. The fasteners 127, in various embodiments, fasten the reinforcement plates 126a and 126b to the siderails 111 and 112 (e.g., to a web portion of the siderails 111 and 112).

For example, the fasteners 127 may be rivets or other fasteners known to persons of skill in the art. In various embodiments, the fasteners 127 may proceed through the handrails 111 via holes in the reinforcement plates 126a and 126b, as described below. In various embodiments, the crossbars 124 are disposed between rungs 113 of the ladder 110 and may be located generally halfway between two consecutive rungs 113.

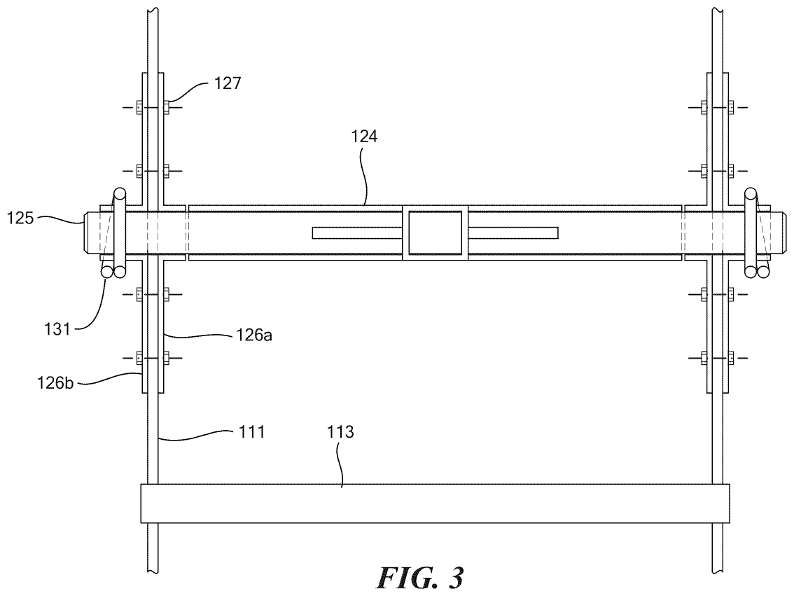

FIG. 3 is a sectional view of a portion of the integrated ladder attachment 120 of FIGS. 2A and 2B in accordance with various embodiments. As shown in FIG. 3, the crossbar 124 is disposed between the inner face 111b of the siderail 111 and inner face 112b of the siderail 112. The pin 125 is disposed within the hollow area of the crossbar 124. In various embodiments, the pin 125 proceeds from an outer area of the siderail 111 (e.g., beyond the outer face 111a of the siderail 111) entirely through the crossbar 124 to an outer area of the siderail 112 (e.g., beyond the outer face 112a of the siderail 112).

The pin 125 also proceeds through an opening of each outer reinforcement plate 126b affixed to the siderails 111 and 112, respectively and an opening of each inner reinforcement plate 126a affixed to the siderails 111 and 112, respectively. As shown in FIG. 3, the reinforcement plates 126a and 126b are affixed to the respective siderails 111 and 112 via the fasteners 127.

The pin 125 also includes holes/openings located at each end through which a baling pin 131 may be inserted to prevent the pin 125 from movement within the crossbar 124. Although two baling pins 131 are shown in FIG. 3, persons of skill in the art will appreciate that only one baling pin 131 or other movement prevention (e.g., cotter pin) may be utilized to maintain the pin 125 from movement.

Accordingly, as shown in FIG. 3, the pin 125 is disposed within a hollow cavity of the crossbar 124. That is, in various embodiments, it may be inserted from one end (opening) of the crossbar 124, proceeding the axial length of the crossbar 124 within the hollow cavity and exiting the opposite end of the crossbar 124.

Also, as shown in FIG. 3, the pin 125 proceeds on either end of the crossbar 124 beyond a flange (described in further detail below) and is secured in the flange via the baling pin 131 on each end. Again, as shown in FIG. 3, the pin 125 is secured by a baling pin 131 on each side, however, persons of skill in the art may appreciate that the pin 125 may be secured on only a single side.

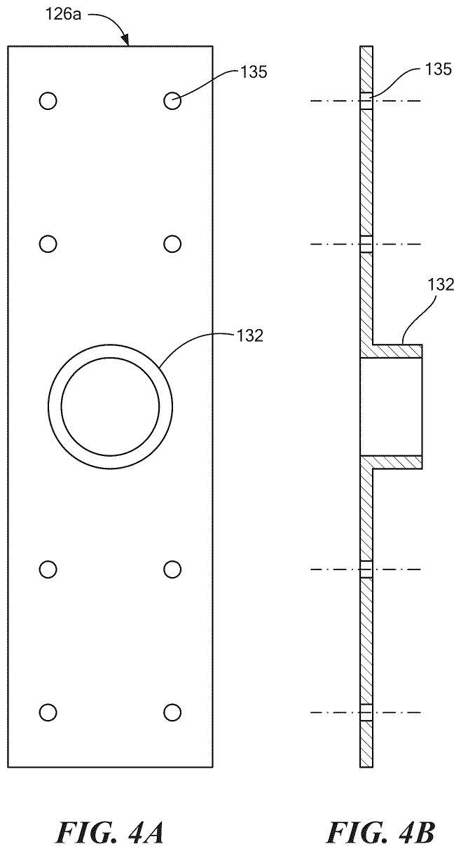

FIG. 4A is a side elevation of the inner reinforcement plate 126a of the integrated ladder attachment 120 in accordance with various embodiments. FIG. 4B is a front cross section elevation of the inner reinforcement plate 126b of the integrated ladder attachment 120 in accordance with various embodiments.

As shown in FIGS. 4A and 4B, the inner reinforcement plate 126a include a flange 132 and one or more holes/openings 135 through which fasteners 127 may be inserted. In various embodiments, the flange 132 of the inner reinforcement plate 126a is situated on a side of the inner reinforcement plate 126b opposite the side that is proximate to the ladder rails 111 or 112.

Accordingly, in various embodiments, each end of the crossbar 124 physically meets with the flange 132. In various embodiments, the inner diameter of the flange 132 is substantially similar to the inner diameter of the crossbar 124 defining the hollow channel of the crossbar 124 and the outer diameter of the flange 132 is substantially similar to the outer diameter of the crossbar 124.

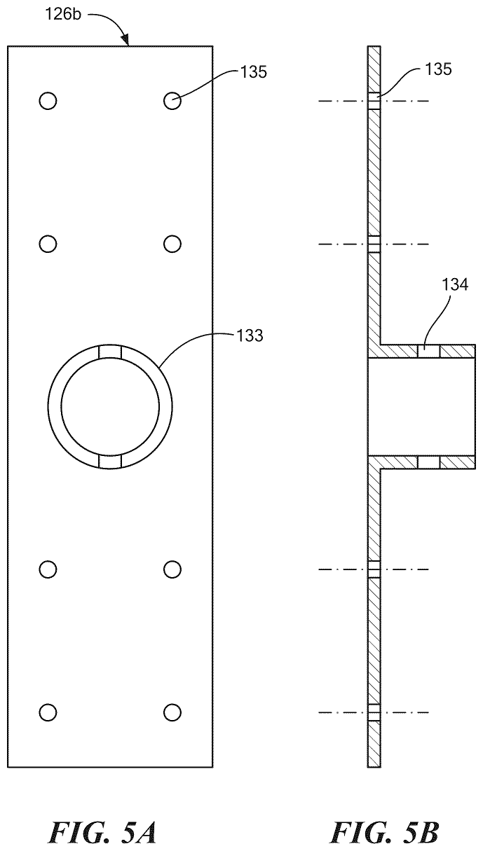

FIG. 5A is a side elevation of the outer reinforcement plate 126b of the integrated ladder attachment 129 in accordance with various embodiments. FIG. 5B is a front elevation of the outer reinforcement plate 126b of the integrated ladder attachment 120 in accordance with various embodiments.

As shown in FIGS. 5A and 5B, the outer reinforcement plate 126b includes a flange 133 and one or more holes/openings 135 through which fasteners 127 may be inserted. In various embodiments, the flange 133 of the inner reinforcement plate 126b is situated on a side of the outer reinforcement plate 126b opposite the side that is proximate to the ladder rails 111 or 112.

Accordingly, in various embodiments, each end of the pin 125 is inserted and is situated inside flange 133. In various embodiments, the flange 133 includes holes/openings 134 that may be disposed relative to the holes/openings of the pin 125 such that the baling pin 131 or other fastener may be inserted through the openings of both to secure the pin 125 in place within the flange 133.

In various embodiments, the components of the integrated ladder attachment 120 may be formed of material to hold a weight such as a board or plank. In various embodiments, the board or plank may act as a scaffold where a person stands. Accordingly, the components described above of the integrated ladder attachment 120 may be formed of aluminum or other such materials capable of supporting the weight of one or more humans and associated tools.

While the present disclosure has been illustrated and described in detail in the drawings and foregoing description, the same is to be considered as illustrative and not restrictive in character, it being understood that only certain exemplary embodiments have been shown and described, and that all changes and modifications that come within the spirit of the present disclosure are desired to be protected. It should be understood that while the use of words such as “preferable,” “preferably,” “preferred” or “more preferred” utilized in the description above indicate that the feature so described may be more desirable, it nonetheless may not be necessary, and embodiments lacking the same may be contemplated as within the scope of the present disclosure, the scope being defined by the claims that follow. In reading the claims, it is intended that when words such as “a,” “an,” “at least one,” or “at least one portion” are used there is no intention to limit the claim to only one item unless specifically stated to the contrary in the claim. The term “of” may connote an association with, or a connection to, another item, as well as a belonging to, or a connection with, the other item as informed by the context in which it is used. The terms “coupled to,” “coupled with” and the like include indirect connection and coupling, and further include but do not require a direct coupling or connection unless expressly indicated to the contrary. When the language “at least a portion” or “a portion” is used, the item can include a portion or the entire item unless specifically stated to the contrary. Unless stated explicitly to the contrary, the terms “or” and “and/or” in a list of two or more list items may connote an individual list item, or a combination of list items. Unless stated explicitly to the contrary, the transitional term “having” is open-ended terminology, bearing the same meaning as the transitional term “comprising.”

The embodiments of the invention described above are intended to be merely exemplary; numerous variations and modifications will be apparent to those skilled in the art. Such variations and modifications are intended to be within the scope of the present invention as defined by any of the appended claims. It shall nevertheless be understood that no limitation of the scope of the present disclosure is hereby created, and that the present disclosure includes and protects such alterations, modifications, and further applications of the exemplary embodiments as would occur to one skilled in the art with the benefit of the present disclosure.

1. An integrated ladder attachment, comprising:
a first hollow crossbar having a first end and a second end, the first crossbar disposed between a first pair of rungs on a ladder and between a first and a second siderail of the ladder;
a second hollow crossbar having a first end and a second end, the second crossbar disposed between a second pair of rungs on a ladder and between the first and the second siderail of the ladder;
a first beam having a first end and a second end, the first end of the first beam attached to the first crossbar and proceeding substantially perpendicular therefrom away from the ladder;
a support beam having a first end and a second end, the first end of the support beam attached to the first beam and proceeding angularly toward the ladder;
a second beam having a first end and a second end, the first end of the second beam attached proximate the first end of the first beam and proceeding substantially perpendicularly therefrom and substantially parallel to a longitudinal axis of the ladder, and wherein the second end of the second beam is attached proximate to the second end of the support beam;
a first pin having a first end and a second end, disposed within the first hollow crossbar, the first pin proceeding through the first siderail of the ladder and through the second siderail of the ladder; and
a second pin having a first end and a second end, disposed within the second hollow crossbar, the second pin proceeding through the first siderail of the ladder and through the second siderail of the ladder.

2. The integrated ladder attachment of claim 1, further comprising:
a first inner reinforcement plate attached to an inner side of the first siderail;
a second inner reinforcement plate attached to an inner side of the second siderail;
a first outer reinforcement plate attached to an outer side of the first siderail; and
a second outer reinforcement plate attached to an outer side of the second siderail,
wherein the first pin is inserted through the first outer reinforcement plate, the first inner reinforcement plate, the second inner reinforcement plate and the second outer reinforcement plate.

3. The integrated ladder attachment of claim 2, wherein the first inner reinforcement plate, the second inner reinforcement plate, the first outer reinforcement plate and the second outer reinforcement plate each include one or more openings.

4. The integrated ladder attachment of claim 3, further comprising one or more fasteners through each of the one or more openings.

5. The integrated ladder attachment of claim 2, wherein the first inner reinforcement plate, the second inner reinforcement plate, the first outer reinforcement plate and the second outer reinforcement plate each include a flange.

6. The integrated ladder attachment of claim 5, wherein each flange is circular and wherein the first pin is inserted through each flange.

7. The integrated ladder attachment of claim 6, wherein the first pin comprises an opening proximate to the first end of the first pin, and the first outer reinforcement plate flange includes one or more openings.

8. The integrated ladder attachment of claim 7, further comprising a bail pin inserted into the opening proximate to the first end of the first pin and the one or more openings of the flange of the first outer reinforcement plate.

9. The integrated ladder attachment of claim 6, wherein the first pin comprises an opening proximate to the second end of the first pin, and the second outer reinforcement plate flange includes one or more openings.

10. The integrated ladder attachment of claim 9, further comprising a bail pin inserted into the opening proximate to the second end of the first pin and the one or more openings of the flange of the second outer reinforcement plate.

11. The integrated ladder attachment of claim 1, wherein the first end of the first beam is attached generally centrally to the first crossbar.

12. The integrated ladder attachment of claim 1, wherein the support beam is attached generally centrally to the second crossbar.

13. The integrated ladder attachment of claim 1, further comprising one or more knife plates attached at the first end of the first beam.

14. The integrated ladder attachment of claim 13, wherein a first knife plate of the one or more knife plates is disposed on an opposite side of the first beam from a second knife plate of the one or more knife plates.

15. The integrated ladder attachment of claim 1, further comprising a guard rail post receiver disposed at the second end of the first beam.

16. A ladder, including:
a first siderail having an outer side and an inner side;
a second siderail having an outer side and an inner side;
one or more spaced rungs proceeding between the inner side of the first siderail and the inner side of the second siderail; and
a first ladder attachment, the ladder attachment comprising:
a first hollow crossbar having a first end and a second end, the first crossbar disposed between a first pair of rungs on the ladder and between the inner sides of the first and the second siderail of the ladder;
a second hollow crossbar having a first end and a second end, the second crossbar disposed between a second pair of rungs on a ladder and between the inner sides of the first and the second siderail of the ladder;
a first beam having a first end and a second end, the first end of the first beam attached to the first crossbar and proceeding substantially perpendicular therefrom away from the ladder;
a support beam having a first end and a second end, the first end of the support beam attached to the first beam and proceeding angularly toward the ladder;
a second beam having a first end and a second end, the first end of the second beam attached proximate the first end of the first beam and proceeding substantially perpendicularly therefrom and substantially parallel to a longitudinal axis of the ladder, and wherein the second end of the second beam is attached proximate to the second end of the support beam;
a first pin, disposed within the first hollow crossbar, the first pin proceeding through the first siderail of the ladder and through the second siderail of the ladder; and
a second pin, disposed within the second hollow crossbar, the second pin proceeding through the first siderail of the ladder and through the second siderail of the ladder.

17. The ladder of claim 16, further comprising:
a first inner reinforcement plate attached to an inner side of the first siderail;
a second inner reinforcement plate attached to an inner side of the second siderail;
a first outer reinforcement plate attached to an outer side of the first siderail; and
a second outer reinforcement plate attached to an outer side of the second siderail,
wherein the first pin is inserted through the first outer reinforcement plate, the first inner reinforcement plate, the second inner reinforcement plate and the second outer reinforcement plate.

18. The ladder of claim 17, wherein the first inner reinforcement plate, the second inner reinforcement plate, the first outer reinforcement plate and the second outer reinforcement plate each include one or more openings, wherein one or more fasteners is disposed through each of the one or more openings.

19. The ladder of claim 17, wherein the first inner reinforcement plate, the second inner reinforcement plate, the first outer reinforcement plate and the second outer reinforcement plate each include a flange.

20. The ladder of claim 19, wherein each flange is circular and wherein the first pin is inserted through each flange.
